(19) United States
(12) Patent Application Publication
(10) Pub. No.: US 2007/0133766 A1
(43) Pub. Date: Jun. 14, 2007

(54) Monitoring apparatus

(76) Inventors: Takeaki Mishima, Narashino (JP); Seigo Kurokawa, Narashino (JP); Ichiro Takahashi, Inzai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/634,958

(22) Filed: Dec. 7, 2006

(30) Foreign Application Priority Data
Dec. 9, 2005 (JP) 2005-356269

(51) Int. Cl. H04M 11/00

(52) U.S. Cl. 379/100.05

(57) ABSTRACT

A monitoring apparatus having a plurality of communication units, each of which incorporates therein a communication control section, a control section and a memory section, and executes programs for communicating with monitoring terminals via a communication network; and memory units, each storing data therein. The monitoring apparatus has a function that at least one of the plural communication units decides on whether or not the operations of the other communication units are normal, depending on the contents of its communications with the other communication units, and also a function that the decision is displayed on a personal computer placed outside the monitoring apparatus.

### INCORPORATION BY REFERENCE

The present application claims priority from Japanese application JP 2005-356269 filed on Dec. 9, 2005, the content of which is hereby incorporated by reference into this application.

### BACKGROUND OF THE INVENTION

This invention relates to a technique for providing a monitoring system for remotely monitoring and controlling a water supply system, a sewage system, an industrial manufacturing facility or a sales data collecting system.

A monitoring system has been conventionally known wherein a main monitoring apparatus and a monitoring terminal communicate with each other so as to monitor a facility. For example, JP-A-2001-177657 document discloses such a conventional monitoring system. In general, a monitoring apparatus needs to operate without interruption so that it may continuously collect data without flaw. For this purpose, when it happens to malfunction, it must be quickly restored to its normal state.

### SUMMARY OF THE INVENTION

The conventional monitoring system disclosed in the above mentioned patent document, in most cases, uses a personal computer as a central monitoring device. Accordingly, the CPU in the personal computer connects dedicated signal lines with devices to be monitored when it is necessary to check whether they are operating normally or not. With this system, however, if the number of devices to be monitored increases and the whole system becomes complicated, it becomes difficult to accurately locate the point of a failure. In the cases where a personal computer was not used, a kind of warning lamp installed per device has been provided to indicate malfunction of each device.

The problems associated with the conventional monitoring system described above will be summarized as follows.

(1) Difficulty in locating the point of failure in the monitoring system:

Since the system must be operated continuously without interruption, it is necessary for it to quickly locate the point of a failure and to remove the malfunction. However, the conventional monitoring system itself fails very often when one of its constituent devices malfunctions, causing a problem that the location of the failure becomes difficult. For example, in a monitoring system using a personal computer, if a main part such as a CPU or a hard disc drive fails, the personal computer itself becomes unable to be started. As a result, in order to locate the point of the failure, the computer must be disassembled to check its constituent parts by inspecting their individual functions.

(2) Lack of indicators to externally indicate the location of failure:

The conventional monitoring system has made it a rule to monitor its operating condition by itself. For example, the conventional monitoring system incorporating a personal computer therein has its operating condition displayed on the screen of the personal computer. In the conventional system not using a personal computer, on the other hand, the abnormal operating condition of a particular constituent device has been indicated by the activation of an LED associated with and installed on the specific device. Accordingly, to check the operating condition of the monitoring system, an administrator had to go to the place where the system is installed.

(3) Necessity of provision of dedicated hardware and signal lines for failure indication:

The conventional monitoring system has used dedicated signal lines for checking the operating condition, and malfunctioning has been detected by detecting abnormal signals appearing on the signal lines. Accordingly, the increase in the number of signals desired to be checked must be accompanied by the increase in the number of the signal lines, which necessitates the modification or replacement of the hardware.

With the above mentioned problems in mind, the present inventor proposes the following countermeasures.

(1) Inspection of system constituents by using remote communication:

Communication is made between a communication apparatus and each of the constituent devices of a monitoring apparatus; the communication apparatus decides on whether such communication condition is normal or not; and the result of the decision is once stored in the memory in the communication apparatus and then displayed on the screen of an externally provided personal computer.

Usually, communication between the communication apparatus and the memory unit is made for data writing and storing, but for this particular purpose, virtual data are written in or read out of the memory unit so as to check whether memory function is properly performed or not.

Communication among communication apparatuses aims to share among them the data acquired from terminal stations or the internal data of a monitoring apparatus. Such communication includes the incremental counting made at regular intervals according to the communication program of an originator. When the communication program stops operating due to malfunction in a communication apparatus, the incremental counting also stops so that it is judged that there is a failure.

Communication between a communication apparatus and an input/output (I/O) device involves the periodical reading of the stored content of the I/O device by the communication apparatus. The I/O device has a counter associated with the periodical reading by the communicating apparatus and the counter counts the frequency of the periodical reading. If the counting continues, it is determined that the I/O device is operating properly. Also, in the memory unit of the I/O device may be provided a counter which incrementally counts whenever the communication apparatus writes a numerical value in the unit. By monitoring the counter by the I/O device, the judgement is made of whether the communication apparatus is operating properly or not.

According to the constitution described above as an embodiment of this invention, there is provided a monitoring apparatus wherein the internal devices are constituent units which can operate individually, the operating condition of the monitoring apparatus is displayed through a remote monitoring technique, and the operating conditions of general-purpose parts are inspected through communication.

This invention can provide a monitoring system that is more reliable than the conventional counterparts.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates the general structure of a monitoring system as an embodiment of this invention;

FIG. 2 schematically shows the flow of signals between a monitoring apparatus and a monitoring terminal, both used in the monitoring system shown in FIG. 1;

FIG. 3A and FIG. 3B illustrate in block diagram the monitoring apparatus (central) and the monitoring terminal (remote), shown in FIG. 1, respectively;

FIG. 4 shows how inquiry and response are performed in the monitoring system shown in FIG. 1;

FIG. 5 illustrates the actual inquiry and response data used in the monitoring system shown in FIG. 1; and

FIG. 6 depicts the visual image of the operating condition of the monitoring system shown in FIG. 1, displayed on a screen.

### DESCRIPTION OF THE EMBODIMENT

The best mode in which this invention is embodied will now be described. An embodiment of this invention will be described below with reference to the attached drawings.

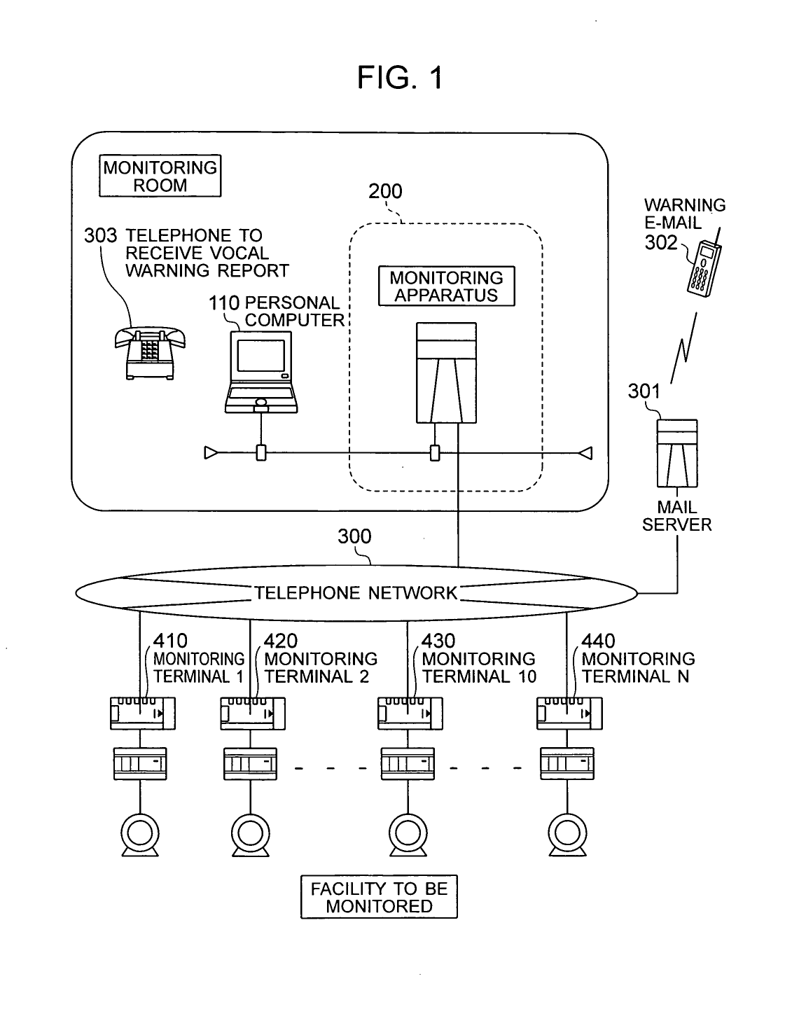

FIG. 1 shows the entire structure of a monitoring system as an embodiment of this invention. A monitoring apparatus 200 installed in a monitoring room communicates with monitoring terminals 410-440 via telephone network 300 so as to monitor the operating condition of a facility to be monitored. The monitoring system as this embodiment has three principal functions: the first is to provide the real time display of the time sequential data obtained from the facility being monitored on the screen of the monitoring apparatus 200; the second is to transmit to a portable telephone 302 a signal in the form of a warning mail compiled in the monitoring apparatus 200 when there is a malfunction in the facility being monitored, and to warn an administrator of the failure; and the third is for the monitoring apparatus 200 to collect the operating records stored in the monitoring terminals 410-440 and to store them therein.

The monitoring apparatus 200 supports communication between the monitoring room and the monitoring terminals 410-440 and also serves to collect the operating records stored in the monitoring terminals 410-440 and to store them in it. A personal computer 110 fetches the data stored in the monitoring apparatus 200 via a LAN and displays the fetched data on its screen. The personal computer can display such data even when it is placed outside the monitoring room.

Each of the monitoring terminals 410-440 has the minimum function of monitoring a facility to be monitored without the help of the monitoring apparatus 200. Namely, when a malfunction occurs in the facility being monitored, the dedicated monitoring terminal, on one hand, can send out a vocal warning report to a telephone 303 installed to receive such a report and, on the other hand, can connect itself with a mail server 301 to send out a warning e-mail to the portable telephone 302. These two functions of the monitoring terminal can cause the administrator of the facility to notice the malfunction quickly when a malfunction occurs in the facility being monitored. Accordingly, the administrator can make a quick access to the malfunction and perform a repair work to maintain the system in the normal condition.

As a simplified version of the embodiment of this invention, a monitoring system may be composed of the monitoring terminals 410-440, the telephone 303 installed to receive a vocal warning report and the portable telephone 302, dispensing with the monitoring apparatus 200.

In order to do without the monitoring apparatus 200, the monitoring terminals 410-440 store data used to represent the operating condition of the monitored facility in the form of voice or e-mail.

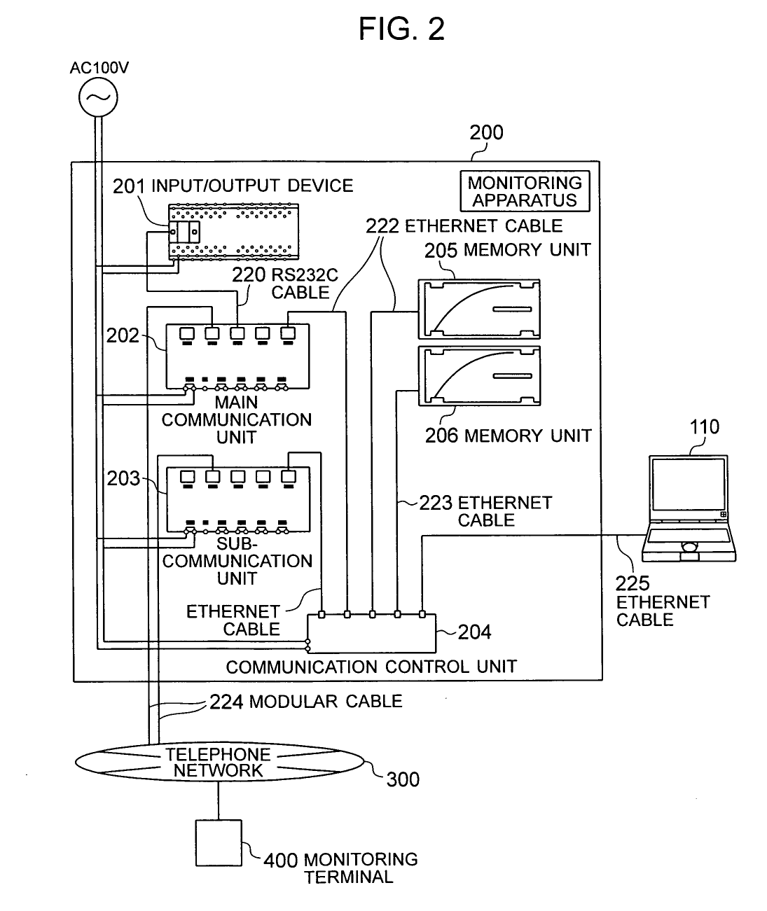

FIG. 2 shows the constituent devices of the monitoring apparatus 200, interconnected with one another. The monitoring apparatus 200 comprises an input/output (I/O) device 201, a main communication unit 202, an auxiliary (or sub-) communication unit 203, memory units 205 and 206, and communication control unit 204. The main communication unit 202, the sub-communication unit 203 and the memory units 205 and 206 are connected with a personal computer by way of a the communication control unit 204 by the use of the Ethernet cable 225 in a manner of Ethernet connection. The communication control unit 204 serves as a hub and the personal computer 110 serving as a display is connected with the communication control unit 204.

The main communication unit 202 serves to adjust all the constituent devices included in the monitoring apparatus 200 and to display the monitoring data by performing a function which a Web server has. The two communication units 202 and 203 communicate with the monitoring terminal 400 as a subordinate station to collect the data stored in the terminal 400 via the telephone network 300. The collected data are then sent out to the memory units 205 and 206 via Ethernet cables 222 and stored in them. The memory units 205 and 206 are network drives which can perform the writing and reading of data via a network. The I/O device 201 is a PLC (programmable logic controller) which controls the signals input to and output from the switches and LEDs installed on the housing of the monitoring apparatus 200. The I/O device 201 communicates with the main communication unit 202 via RC232C cable 220.

The main communication unit 202 decides on whether the devices incorporated in the monitoring apparatus 200 are operating normally or not, and the way of checking the operation depends on which device is to be monitored. For example, whether or not the I/O device 201 is operating normally is checked depending on its status of communication with the main communication unit 202 while the normal operation of the sub-communication unit 203 is assured so far as the operation checking counter continues its incremental counting. The normal operations of the memory units 205 and 206 are checked depending on whether or not they can communicate with the main communication unit 202 and whether or not data can be written in and read out of the file preserved in each of them. The main communication unit 202 compiles the result of checking into html data, which can be accessed from the personal computer serving as a display by way of a Web-server. The abnormal operation of the main communication unit 202 is detected by the I/O device 201 and then indicated by the associated LED of the monitoring apparatus 200.

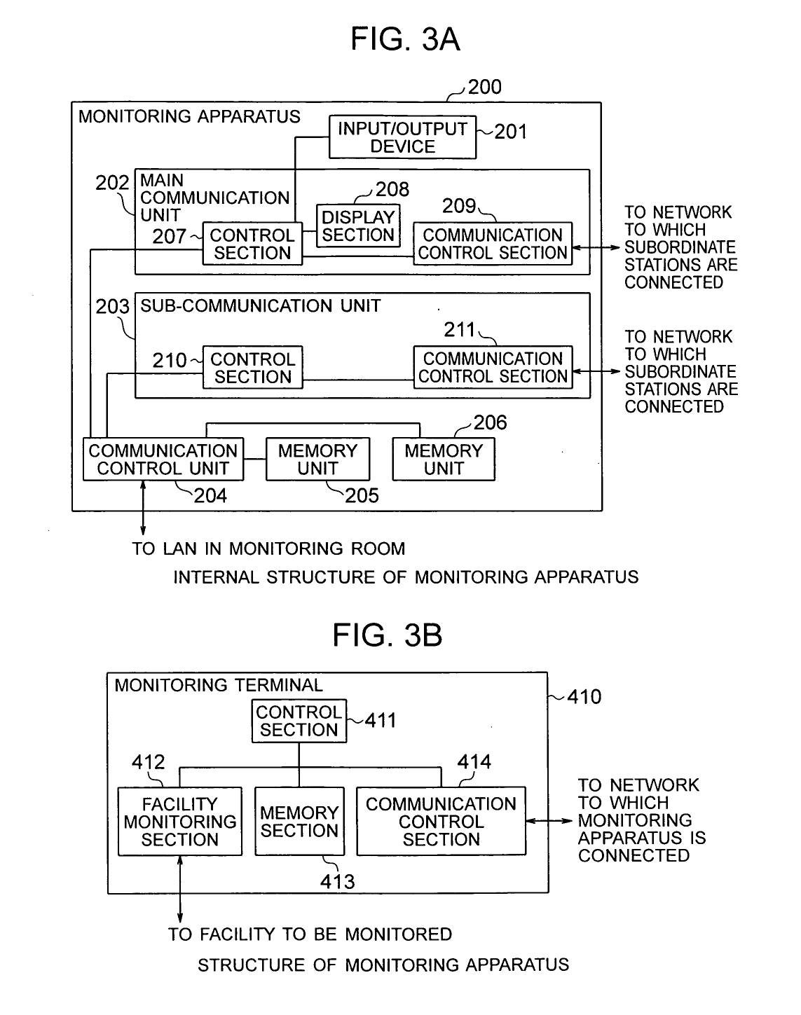

FIGS. 3A and 3B show in block diagram the monitoring apparatus 200 and the monitoring terminal 410, respectively. The monitoring apparatus 200 incorporates therein the main communication unit 202, the sub-communication unit 203, the input/output (I/O) device 201, the communication control unit 204, and the memory units 205 and 206. The communication units 202 and 203 serve to execute monitoring programs. The main communication unit 202 also controls the operations of the I/O device 201 and the memory units 205 and 206. The communication units 202 and 203 further comprise control sections 207 and 210 for executing the programs and communication control sections 209 and 211 for communicating with subordinate stations. Of the two communication units 202 and 203, the main communication unit 202 also includes a display section 208 for displaying the monitoring data of the monitoring system on the screen of the personal computer by way of the communication control unit 204. The communication control unit 204 connects the communication units 202 and 203 with the memory units 205 and 206 via a LAN and also lets all these units be connected with the LAN in the monitoring room to enable all of them to communicate with the personal computer 110 serving as a display. The I/O device 201 controls the signal input to and output from the monitoring apparatus 200.

The communication units 202 and 203 have the function of executing programs in the communication terminals and the function of controlling the monitoring terminals through the control of a modem connected with the communication network to which the monitoring terminals are connected. The main communication unit 202 controls the operations of the I/O device 201 and the memory unit 205 in the monitoring apparatus 200. Of the two communication units 202 and 203, the main communication unit 202 also includes a display section 208 connected with an external circuit via a LAN.

The monitoring terminal 410 shown in FIG. 3B incorporates therein a control section 411, a facility monitoring section 412, memory section 423 and a communication control section 414. The control section 411 executes programs and controls the operation of the terminal 410 as a whole. The facility monitoring section 412 is connected with a facility to be monitored, and collects monitoring data and receives warning signals. The memory section 413 stores monitoring data for the facility to be monitored. The communication control section 414 is connected with a communication network to communicate with the monitoring apparatus 200.

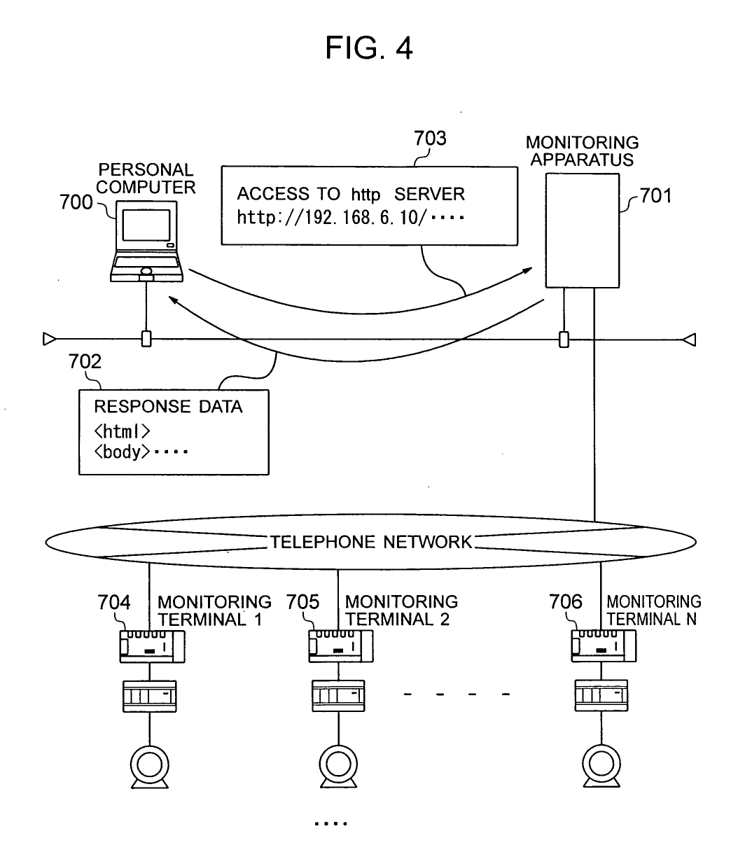

FIG. 4 shows an example of data content communicated between a monitoring apparatus 701 and a personal computer 700 serving as a display. The personal computer 700 accesses the main communication unit of the monitoring apparatus 701 by using the browser incorporated therein, and displays the operating condition by the use of the server function the main communication unit has in it. The data to be displayed as images are in the html format.

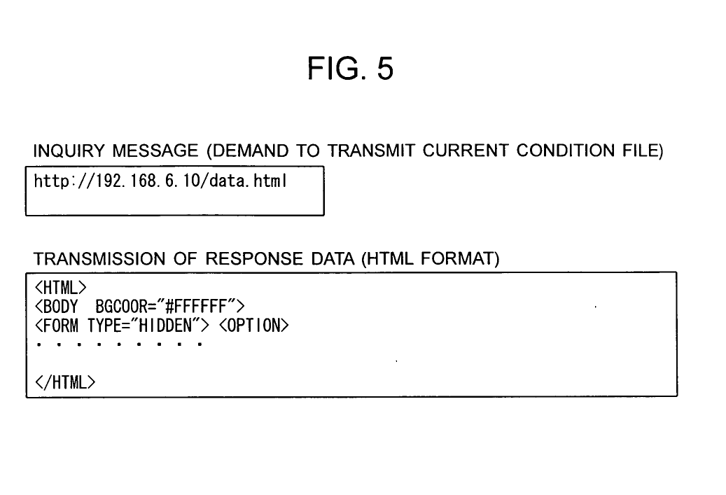

FIG. 5 shows an example of communication data used in the embodiment of this invention. When accessed by the personal computer 700 serving as a display, the main communication unit of the monitoring apparatus 701 sends out data of the html format. The computer 700 utilizes its general-purpose web browser so as to display the html data on the screen thereof. Therefore, the computer 700 can dispense with a dedicated software which otherwise needs to be installed, so that monitoring using only the general-purpose software can be effected.

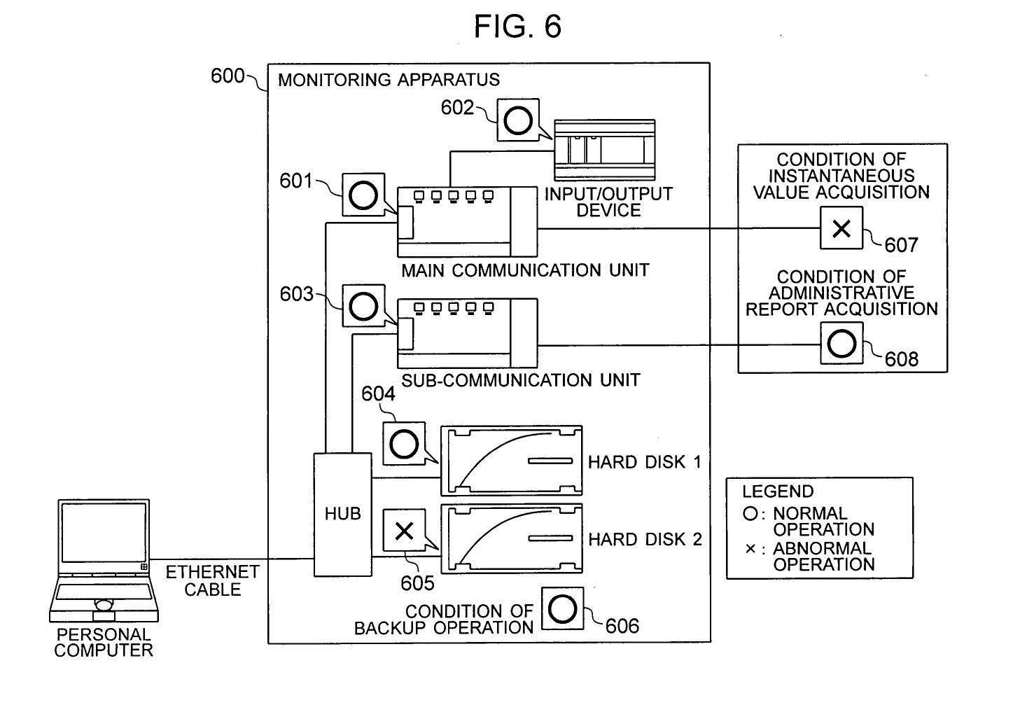

FIG. 6 shows examples of images displayed on the screen of the personal computer 700. On the screen is shown the interconnection among the constituent devices of a monitoring apparatus 600 in a manner of illustration. In the displayed image, the monitoring apparatus 600 has a display section 601 for indicating the operating condition of the main communication unit incorporated in the monitoring apparatus 600. The display section 601 represents the operating condition of the main communication unit by O (circle) or X (cross), circle and cross designating “normal” and “abnormal”, respectively. Thus, this representation is such that a glance at the screen immediately tells whether the device on display is operating normally or abnormally. Further, in the monitoring apparatus 600 are incorporated a display section 602 for indicating the operating condition of the I/O device; a display section 603 for indicating the operating condition of the sub-communication unit; a display section 604 for indicating the operating condition of the hard disk 1 serving as a memory unit; and a display section 605 for indicating the operating condition of the hard disk 2 serving likewise as a memory unit. Moreover, in addition to the display of the operating conditions of the internal devices, display can be effected either of such conditions of communication with external entities as regarding whether or not there is an error in the communication between the monitoring apparatus and one of the remote subordinate stations, or of the results of software operations. For example, while the main communication unit is operating free of malfunctioning, its display section 601 indicates “O”. But if a remote subordinate station is abnormal with the result that instantaneous values have not been retrieved, then “X” is indicated on the display section 607 for displaying the status of retrieving instantaneous values. Furthermore, in order to display the conditions of operations to be monitored, there are provided a display section 606 for displaying the condition of backup operation and a display section 608 for displaying the condition of retrieving the administrative logs. Accordingly, a single screen can display all the necessary conditions of operations associated with the monitoring apparatus as a whole. The displayed images are periodically renewed so as to make the real time representation of the change in operating conditions.

The principal features as described with the embodiment of this invention will now be summarized as follows.

(1) Each of the internal components of the monitoring apparatus can be made up of individual units which can operate independently.

The monitoring apparatus comprises the interface section, the control section, the memory section and the communication control section. Each section is composed of independently operable units. Accordingly, if the control section and the communication section are operating normally, then even though other sections are malfunctioning, the operating condition of each of the internal components of the monitoring apparatus can be monitored.

(2) The operating condition of the monitoring apparatus can be displayed in a remote place.

With the conventional monitoring apparatus, the operating conditions of the individual components were usually displayed on the CRT display installed nearby or indicated by lighting the LEDs attached to the components themselves. As a result of this, the operating condition of the monitoring apparatus could be checked only in the place where the monitoring apparatus was installed. On the other hand, if such operating conditions can be displayed on the screen of a personal computer placed outside the monitoring apparatus, the operating conditions will be able to be remotely inspected in a place different from where the monitoring apparatus is installed. Moreover, since the failure condition of each constituent of the monitoring apparatus is displayed on the display section attached to the constituent itself, the failure can be easily located without disassembling the monitoring apparatus and examining each of its constituents. In addition, since the operating conditions are visualized on the screen, even a user who is not a specialist can recognize the operating conditions.

(3) The operating conditions of general-purpose parts can be retrieved through communication.

With the conventional monitoring apparatus, abnormal signals were detected by the use of dedicated signal lines. According to this invention, however, such detection of abnormality is performed through communication between a communication unit and a component device. Accordingly, such dedicated signal lines can be dispensed with and only standard communication lines for data communication will be necessary. Moreover, the change in the abnormal signal format can be performed only by the change in the communication program so that the operating conditions of general-purpose parts can be displayed without any need of hardware change.

It should be further understood by those skilled in the art that although the foregoing description has been made on embodiments of the invention, the invention is not limited thereto and various changes and modifications may be made without departing from the spirit of the invention and the scope of the appended claims.

1. A monitoring apparatus comprising:
a plurality of communication units, each communication unit incorporating therein a communication control section, a control section and a memory section, and executing programs for communicating with monitoring terminals via a communication network; and
more than one memory unit, each memory unit storing data therein,
wherein at least one of the plural communication units decides on whether or not the operations of the other communication units are normal, depending on the contents of its communications with the other communication units, and the decision is displayed on a personal computer placed outside the monitoring apparatus.

2. A monitoring apparatus as claimed in claim 1, wherein at least one of the plural communication units decides on whether or not the operations of the memory units are normal, depending on the contents of its communications with the memory units, and the decision is displayed on a personal computer placed outside the monitoring apparatus.

3. A monitoring apparatus comprising:
a plurality of communication units, each communication unit incorporating therein a communication control section, a control section and a memory section, and executing programs for communicating with monitoring terminals via a communication network;
more than one memory unit, each memory unit storing data therein, and
an input/output device,
wherein the input/output device decides on whether or not the operations of the communication units are normal, depending on the contents of its communications with the communication units, and the decision is displayed on a personal computer placed outside the monitoring apparatus.

4. A monitoring apparatus as claimed in claim 1, wherein the other communication units store therein data which are incrementally counted; the one communication unit reads the incrementally counted data out of the other communication units through communication with them; and the normal conditions of the operations of the other communication units are ascertained by ensuring that the incrementally counted data are being continually renewed.

5. A monitoring apparatus as claimed in claim 2, wherein the one communication unit ascertains the normal operations of the memory units by ensuring that data are being normally read out of and written into the memory units.

6. A monitoring apparatus as claimed in claim 3, wherein each of the communication units further comprises a counter into which numerical data are written, and the input/output device ascertains the normal operation of the communication unit by checking the numerical data retained in the counter.
